(19) United States
(12) Patent Application Publication
(10) Pub. No.: US 2025/0094984 A1
(43) Pub. Date: Mar. 20, 2025

(54) SYSTEMS AND METHODS FOR USER VERIFICATION VIA SHORT-RANGE TRANSCEIVER

(71) Applicant: Capital One Services, LLC, McLean, VA (US)

(72) Inventors: Samuel Patrick EDWARDS, Richmond, VA (US); Lesley NEWTON, Richmond, VA (US); Clayton JOHNSON, Edgewood, MD (US)

(21) Appl. No.: 18/969,744

(22) Filed: Dec. 5, 2024

Related U.S. Application Data
(63) Continuation of application No. 16/991,504, filed on Aug. 12, 2020, now Pat. No. 12,165,149.

(51) Int. Cl. G06Q 20/40; G06K 7/10; G06K 19/07; G06Q 20/20; G06Q 20/34; H04W 4/80

(52) U.S. Cl. CPC G06Q 20/401; G06K 7/10297; G06K 19/0723; G06Q 20/20; G06Q 20/352; H04W 4/80

(57) ABSTRACT

Systems, methods, and computer-accessible mediums for user verification through the interaction of a short-range transceiver, such as a contactless card, with a client device are presented. User verification may be provided in the context of reading two types of data from the short-range transceiver, such as a contactless card, using a client device, sending the data to a server, obtaining identifiers from each data type and comparing with stored user identifier data. Matching stored user identifier data to two forms of identification data obtained from a short-range transceiver, such as a contactless card, provides an enhanced ability to verify that the short-range transceiver is being used by an authorized user.

### CROSS-REFERENCE TO RELATED APPLICATION

The present disclosure is a continuation of and claims the benefit of priority to U.S. patent application Ser. No. 16/991,504, filed Aug. 12, 2020, now U.S. Pat. No. 12,165,149, the contents of which are incorporated by reference in their entirety.

### FIELD OF THE DISCLOSURE

The present disclosure relates generally to user verification and, more specifically, to exemplary systems, methods, and computer-accessible mediums for verifying a user's short-range transceiver through the interaction of the short-range transceiver with a client device.

### BACKGROUND

The development of electronic commerce has led to the convenience of consumers and businesses alike. Transactions may be conducted between and among parties from virtually any location and at any time. Use of cards such as credit and debit cards has enhanced the ability to conduct transactions over networks, as consumers may engage in purchase transactions, or conduct other business, merely by providing credentials including a name, a card number, and other data such as, for example, a card expiration date, a card security code, or a billing zip code.

But the increasing use of cards has also resulted in increased risk of fraud or theft. When parties are remotely located, it is more difficult to verify a user's identity or to verify that the user is in possession of the card being used for a transaction. Further, much of the data required for a transaction using a card is typically printed on the card and/or contained in a magnetic stripe on the card, making it easier for malevolent parties to misappropriate and misuse the credentials of another to carry out fraud or theft.

These and other deficiencies exist. Thus, it may be beneficial to provide exemplary systems, methods, and computer-accessible mediums which allow for verification of cards being used for transactions, to overcome at least some of the deficiencies described herein.

### SUMMARY

Aspects of the disclosed technology include systems, methods, and computer-accessible mediums for user verification through the interaction of user's short-range transceiver, such as a contactless card, with a client device. User verification may be provided in the context of reading two types of data from the short-range transceiver, such as a contactless card, using a client device such that identifiers and other information may be obtained from each data type and compared with stored information, including stored user identifier data. Matching stored user identifier data to two forms of identification data obtained from a short-range transceiver, such as a contactless card, provides an enhanced ability to verify that the short-range transceiver is being used by an authorized user.

Embodiments of the present disclosure provide a card verification system, comprising: a database storing user identifier information for a plurality of contactless cards; a contactless card comprising a processor and a memory, the memory storing first data of a first type, second data of a second type, a first applet configured to provide the first type data, and a second applet configured to provide the second type data, wherein the contactless card is associated with a user; and a server configured to communicate over a network with the contactless card and the database; wherein, after entry into a short-range communication field, the contactless card is configured to transmit the first type data and the second type data to the server, and wherein, after receipt of the first type data and the second type data, the server is configured to: determine a first user identifier based on the first type data, determine a second user identifier based on the second type data, determine whether the first user identifier and the second user identifier both correspond to the contactless card associated with the user, and transmit a card verification message.

Embodiments of the present disclosure provide a method for card verification, comprising: establishing a database storing user identifier information for a plurality of contactless cards; receiving, via a network, a card verification request to verify a contactless card, the card verification request generated in response to entry by the contactless card into a short-range communication field, the card verification request accompanied by first type data read from the contactless card and by second type data read from the contactless card, wherein the contactless card is associated with a user; determining a first user identifier based on the first type data; determining a second user identifier based on the second type data; determining whether the first user identifier and the second user identifier both correspond to the contactless card associated with the user; and transmitting, via the network, a card verification message.

Embodiments of the present disclosure provide a method for card verification, comprising: establishing a database storing user identifier information for a plurality of contactless cards; providing a contactless card configured for data communication via near field communication (NFC), the contactless card comprising a processor and a memory, the memory storing NFC data exchange format (NDEF) data, Europay Mastercard Visa (EMV) data, a first applet configured to provide the NDEF data responsive to an NDEF read request, and a second applet configured to provide the EMV data responsive to an EMV read request, wherein the contactless card is associated with a user; and providing a server in communication with the contactless card via a network, the server configured to receive the NDEF data and the EMV data and transmit a card verification message, the card verification message based on determining whether a first user identifier associated with the NDEF data and a second user identifier associated with the EMV data both correspond to the contactless card associated with the user.

### BRIEF DESCRIPTION OF THE DRAWINGS

FIG. 1A is a diagram of a user verification system according to one or more example embodiments.

FIG. 1B is a diagram illustrating a sequence for providing user verification according to one or more example embodiments.

FIG. 2 illustrates components of a client device used in a user verification system according to one or more example embodiments.

FIG. 3 illustrates components of a short-range transceiver used in a user verification system according to one or more example embodiments.

FIG. 4 provides a flowchart illustrating one or more methods of user verification according to one or more example embodiments.

FIG. 5A provides a flowchart illustrating one or more methods of user verification according to one or more example embodiments.

FIG. 5B provides a flowchart illustrating one or more methods of user verification according to one or more example embodiments.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Exemplary embodiments of the disclosed systems and methods provide for user verification through the interaction of a short-range transceiver, such as a contactless card, with a client device. User verification may be provided in the context of reading two types of data from the short-range transceiver, such as a contactless card, using a client device, sending the data to a server, obtaining identifiers from each data type and comparing with stored user identifier data. Benefits of the disclosed technology may include improved user verification, since two identifiers are used to verify that the short-range transceiver (e.g., contactless card) corresponds to the user, improved data security, and improved user experience.

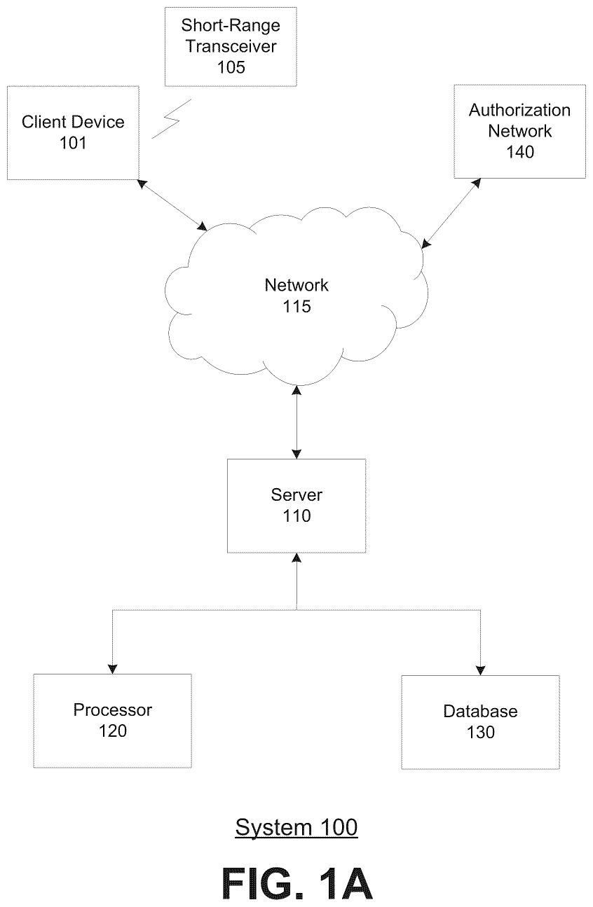

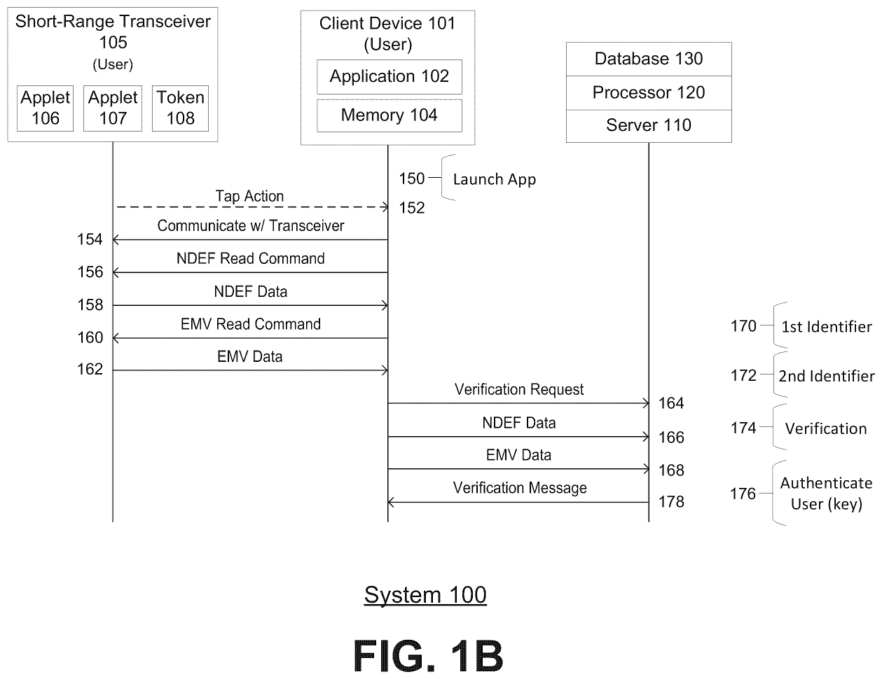

FIG. 1A shows a diagram illustrating a user verification system 100 according to one or more example embodiments. As discussed further below, system 100 may include client device 101, short-range transceiver 105, server 110, processor 120 and database 130. Client device 101 may communicate with server 110 via network 115. Server 110 and/or client device 101 may also communicate with an authorization network 140. Although FIG. 1 illustrates certain components connected in certain ways, system 100 may include additional or multiple components connected in various ways.

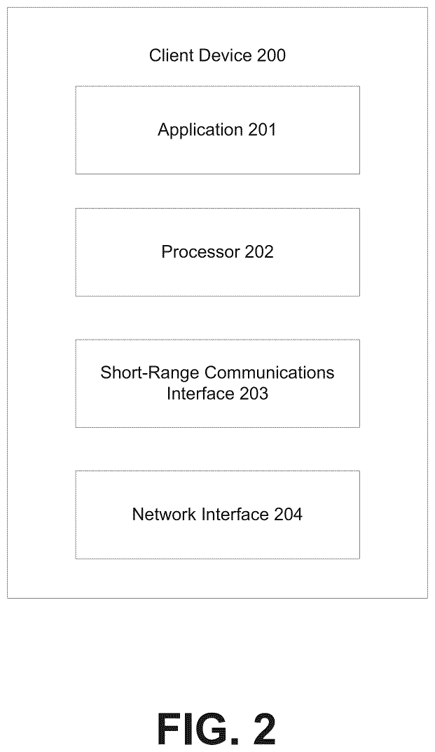

System 100 may include one or more client devices, such as client device 101, which may each be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, contactless card, a smart card, or other device. Client device 101 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some embodiments, client device 101 may be a point of sale (POS) device associated with a POS system. Additional features that may be included in a client device, such as client device 101, are further described below with reference to FIG. 2.

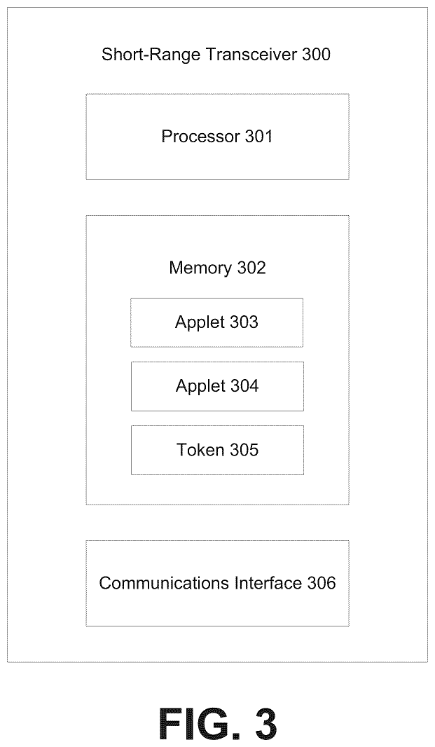

System 100 may include one or more short-range transceivers, such as short-range transceiver 105. Short-range transceiver 105 may be in wireless communication with a client device, such as client device 101, within a short-range communications field such as, for example, near field communication (NFC). Short-range transceiver 105 may include, for example, a contactless card, a smart card, or may include a device with a varying form factor such as a fob, pendant or other device configured to communicate within a short-range communications field. In other embodiments, short-range transceiver 105 may be the same or similar as client device 101. Additional features that may be included in a short-range transceiver, such as such as short-range transceiver 105, are further described below with reference to FIG. 3. It is understood that, in embodiments where the short-range transceiver 105 is a contactless card, the present disclosure is not limited to a particular type of contactless card. Rather, the present disclosure includes any type of contactless card, including payment cards (e.g., credit cards, debit cards, gift cards), identity cards (e.g., identification cards, driver's licenses, Social Security cards, membership cards), and travel cards (e.g., passports, tickets, vouchers).

System 100 may include one or more servers 110. In some example embodiments, server 110 may include one or more processors (such as, e.g., a microprocessor) which are coupled to memory. Server 110 may be configured as a central system, server or platform to control and call various data at different times to execute a plurality of workflow actions. Server 110 may be a dedicated server computer, such as bladed servers, or may be personal computers, laptop computers, notebook computers, palm top computers, network computers, mobile devices, or any processor-controlled device capable of supporting the system 100.

Server 110 may be configured for data communication (such as, e.g., via a connection) with one or more processors, such as processor 120. In some example embodiments, server 110 may incorporate processor 120. In some example embodiments, server 110 may be physically separate and/or remote from processor 120. Processor 120 may be configured to serve as a back-end processor. Processor 120 may be configured for data communication (such as, e.g., via a connection) with database 130 and/or server 110. Processor 120 may include one or more processing devices such as a microprocessor, RISC processor, ASIC, etc., along with associated processing circuitry. Processor 120 may include, or be connected to, memory storing executable instructions and/or data. Processor 120 may communicate, send or receive messages, requests, notifications, data, etc. to/from other devices, such as client devices 101 and/or 103, via server 110.

Server 110 may be configured for data communication (such as, e.g., via a connection) with one or more databases, such as database 130. Database 130 may be a relational or non-relational database, or a combination of more than one database. In some example embodiments, server 110 may incorporate database 130. In some example embodiments, database 130 may be physically separate and/or remote from server 110, located in another server, on a cloud-based platform, or in any storage device that is in data communication with server 110.

Connections between server 110, processor 120 and database 130 may be made via any communications line, link or network, or combination thereof, wired and/or wireless, suitable for communicating between these components. Such network may include network 115 and/or one or more networks of same or similar type as those described herein with reference to network 115. In some example embodiments, connections between server 110, processor 120 and database 130 may include a corporate LAN.

Server 110 and/or database 130 may include user login credentials used to control access to user accounts. The login credentials may include, without limitation, user names, passwords, access codes, security questions, swipe patterns, image recognition, identification scans (e.g., driver's license scan and passport scan), device registrations, telephone numbers, email addresses, social media account access information, and biometric identification (e.g., voice recognition, fingerprint scans, retina scans, and facial scans).

Database 130 may contain data relating to one or more users and one or more accounts. Data relating to a user may include one or more user identifiers (which may include one or more card identifiers), and one or more user keys, and may be maintained or organized in one or more accounts. Accounts may be maintained by (or on behalf of) and/or relate to any one or more of a variety of entities, such as, for example (and without limitation) a bank, merchant, online retailer, service provider, merchandizer, manufacturer, social media provider, provider or promoter of sporting or entertainment events, or hotel chain. For example, database 130 may include, without limitation, account identification information (e.g., account number, account owner identification number, account owner name and contact information--any one or more of which may comprise an account identifier), account characteristics (e.g., type of account, funding and trading limitations, and restrictions on access and other activity), and may include information and data pertinent to the account, including financial (such as balance information, payment history, and transaction history), social and/or personal information. Data stored in database 130 may be stored in any suitable format, and may be encrypted and stored in a secure format to prevent unauthorized access. Any suitable algorithm/procedure may be used for data encryption and for authorized decryption.

Server 110 may be configured to communicate with one or more client devices, such as such as client device 101, and/or with authorization network 140, via one or more networks, such as network 115. Network 115 may include one or more of a wireless network, a wired network or any combination of wireless network and wired network, and may be configured to connect client device 101 to server 110. For example, network 115 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 115 may include, without limitation, telephone lines, fiber optics, IEEE Ethernet 902.3, a wide area network, a wireless personal area network, a LAN, or a global network such as the Internet. In addition, network 115 may support an Internet network, a wireless communication network, a cellular network, or the like, or any combination thereof. Network 115 may further include one network, or any number of the exemplary types of networks mentioned above, operating as a stand-alone network or in cooperation with each other. Network 115 may utilize one or more protocols of one or more network elements to which they are communicatively coupled. Network 115 may translate to or from other protocols to one or more protocols of network devices. Although network 115 is depicted as a single network, it should be appreciated that according to one or more example embodiments, network 115 may comprise a plurality of interconnected networks, such as, for example, the Internet, a service provider's network, a cable television network, corporate networks, such as credit card association networks, a LAN, and/or home networks.

In some example embodiments, server 110 may access records, including records in database 130, to determine a method or methods for communicating with client device 101.

The communication method may include an actionable push notification, or other appropriate communication techniques, with an application stored on client device 101. Other communication methods may include a text message or an e-mail, or other messaging techniques appropriate in a network-based client/server configuration. Messages or requests by client device 101 may be communicated to server 110 via an application on the client device, or may be sent by a text message or an e-mail, or other messaging techniques appropriate in a network-based client/server configuration. Communications originating with client device 101 may be sent to server 110 using the same communications method as communications originating with server 110, or via a different communications method.

In some example embodiments, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the client device 101, short-range transceiver 105, server 110, network 115, and/or database 130, or other computer hardware arrangement.

In some example embodiments, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

Authorization network 140 may include one or more parties that may be in the chain of communication for a transaction authorization request that is sent upon a user's attempt to use an account-linked card for a transaction. Such parties may include a merchant or processing bank (such as, e.g., a bank associated with the point of sale merchant), credit card company or association (such as, e.g., Visa, MasterCard, American Express, etc.), card issuer (e.g., bank issuing the credit card to the user). A transaction request initiated at point of sale device, or via a server, may be transmitted with accompanying card and/or account information for processing to authorization network 140 for authorization of the transaction. A transaction request may be authorized, or rejected, or subject of other status, and the result may be transmitted back to the requesting POS device or server.

FIG. 1B shows a diagram illustrating a sequence for providing user verification according to one or more example embodiments, FIG. 1B references similar components of example embodiment system 100 as illustrated in FIG. 1A. Client device 101 may be associated with a user. Client device 101 may include application 102, which may include instructions for execution by client device 101, and memory 104. Client device 101 may include features further described below with reference to FIG. 2. Application 102 may be configured to provide a user interface for the user when using client device 101. Application 102 may be configured to communicate, via client device 101, with other client devices, with short-range transceiver 105, and with server 110. Application 102 may be configured to receive requests and send messages as described herein with reference to client device 101. User information, including identifiers and/or keys, may be stored in database 130.

Short-range transceiver 105 may be associated with a user, and may be unique to the user and/or to a specific user account. Short-range transceiver 105 may include, for example, a contactless card, and may include features further described below with reference to FIG. 3. Short-range transceiver 105 may have memory storing an applet 106, an applet 107 and/or a token 108. Token 108 may be associated with the user.

A token may be used to increase security through token authorization. Server 110 may send a validation request to a client device, such as client device 101, receive responsive information from the client device, and if validated, send a validation token back to the client device. The validation token may be based on a pre-determined token, or may be a dynamic token based on an algorithm that can be secret and known only to server 110 and the client device; the algorithm may include live parameters independently verifiable by the participants, such as the temperature at a particular location or the time. The token may be used to verify the identity of the user. The validation request and/or validation token may be based on token 108 stored on short-range transceiver 105.

At label 150, the user may launch application 102 running on client device 101. In some embodiments, application 102 may be launched after entry of short-range transceiver 105 into a short-range communication field of client device 101, such as, e.g., in response to a tap action between short-range transceiver 105 and client device 101. Application 102 may require a sign-in or login process, which may be accomplished via, e.g., entering a username and password, or scanning a biometric image such as a fingerprint scan, retina scan, facial scan, etc. In some example embodiments, application 102 may display an instruction on client device 101 prompting the user to initiate a tap action between short-range transceiver 105 and client device 101. As used herein, a tap action may include tapping short-range transceiver 105 against client device 101 (or vice-versa). For example, if short-range transceiver 105 is a contactless card and client device 101 is a mobile device, the tap action may include tapping the contactless card on a screen or other portion of client device 101. However, a tap action is not limited to a physical tap by short-range transceiver 105 against client device 101, and may include other gestures, such as, e.g., a wave or other movement of short-range transceiver 105 in the vicinity of client device 101 (or vice-versa) such that short-range transceiver 105 enters a short-range communication field of client device 101. An action taken in response to a tap action between short-range transceiver 105 and client device 101 may include any responsive action that is initiated upon or after entry of short-range transceiver 105 into the short-range communication field of client device 101.

At label 152, there may be a first tap action between short-range transceiver 105 and client device 101. The first tap action may be in response to a prompt displayed on client device 101 and/or in response to a verification request (not shown) from processor 120 (e.g., via server 110). In some embodiments, a prompt displayed on client device 101 may be displayed in response to a verification request (not shown) from processor 120 (e.g., via server 110).

At label 154, application 102 may communicate (via client device 101) with short-range transceiver 105 (e.g., after short-range transceiver 105 is brought near client device 101). Communication between application 102 and short-range transceiver 105 may involve short-range transceiver 105 (such as, e.g., a contactless card) being sufficiently close to a card reader (not shown) of the client device 101 to enable NFC data transfer between application 102 and short-range transceiver 105, and may occur in response to a tap action between short-range transceiver 105 and client device 101 (such as, e.g., the tap action at label 152). The communication may include exchange of data or commands to establish a communication session between application 102 and short-range transceiver 105. The exchange of data may include transfer or exchange of one or more keys or tokens, which may be preexisting keys or generated as session keys, and/or may include token 108. In some example embodiments, the communication may occur upon entry of short-range transceiver 105 into a short-range communication field of client device 101 prior to a tap action between short-range transceiver 105 and client device 101.

At label 156, application 102 may transmit (via client device 101) to short-range transceiver 105 a first data read command to read data of a first type from short-range transceiver 105. If the short-range communication field is NFC, the first data read command may be a NFC data exchange format (NDEF) command to read NDEF data. In some embodiments, transmitting the first data read command by client device 101 may occur in response to a tap action between short-range transceiver 105 and client device 101 (such as, e.g., the tap action at label 152).

At label 158, short-range transceiver 105 may transmit the requested first type data to application 102 (via client device 101). Transmission of the requested first type data may be responsive to the first data read command (label 156). Applet 106 may execute the read command and read the first type data from memory on short-range transceiver 105 for transmission to client device 101. The first type data may include a first identifier. The first identifier may be associated with the user and/or with short-range transceiver 105. The first identifier may be unique to the user, and may be unique to a specific user account and/or to a specific short-range transceiver. If the first data read command is a NDEF read command, the first type data read and transmitted may be NDEF data. The NDEF data may be, or may include, a NDEF message, and may include a data block of N characters; in some embodiments the data block may be 64 characters.

At label 160, application 102 may transmit (via client device 101) to short-range transceiver 105 a second data read command to read data of a second type from short-range transceiver 105. The second data read command may be a command to read EMV data (i.e. data formatted according to the Europay Mastercard Visa (EMV) standard). Typically, EMV data is organized according to the application protocol data unit (APDU) structure, which includes standard commands to access EMV data. Commands to read EMV data from a contactless card may correspond to commands that may be issued by point-of-sale (POS) devices or payment systems via a smart card reader or contactless card reader. In some embodiments, transmitting the second data read command by client device 101 may occur in response to a tap action between short-range transceiver 105 and client device 101 (such as, e.g., the tap action at label 152, or a second tap action, not shown, between short-range transceiver 105 and client device 101). The second tap action may be in response to a prompt displayed on client device 101. In some embodiments, the second tap action may be of a different motion than the first tap action of label 152. In some embodiments, client device 101 may distinguish between the motion or card position of the first tap action and the motion or card position of the second tap action and issue a read command for a data type corresponding to the particular motion or card position of the tap action. The second data read command can comprise one or more commands including multiple APDUs as necessary.

At label 162, short-range transceiver 105 may transmit the requested second type data to application 102 (via client device 101). Transmission of the requested second type data may be responsive to the second data read command (label 160). Applet 107 may execute the read command and read the second type data from memory on short-range transceiver 105 for transmission to client device 101. The second type data may include a second identifier. The second identifier may be associated with the user and/or with short-range transceiver 105. The second identifier may be unique to the user, and may be unique to a specific user account and/or to a specific short-range transceiver. If the second data read command is an EMV read command (it may be understood that, according to the APDU standard, an EMV read command may involve multiple APDU commands), the second data read and transmitted may be EMV data. EMV data may include a cryptogram generated by applet 107 using the card number, a key on the card and/or a counter stored on the card.

In some embodiments, short-range transceiver 105 may transmit user token 108 to client device 101. In some embodiments, token 108 may be included with the first type data and/or the second type data sent from short-range transceiver 105 to client device 101. Token 108 may include a user identifier, which may be the first identifier or the second identifier described above. In some embodiments, user token 108 may include a key associated with the user; the key may be a preexisting key or generated as a session key. In some embodiments, the sending of user token 108 to application 102 may occur after entry of short-range transceiver 105 into a short-range communication field of client device 101 such as, e.g., in response to a tap action between short-range transceiver 105 and client device 101 (such as, e.g., the tap action at label 152). In addition to user token 108, short-range transceiver may send other data to application 102, including data such as a counter, public key, other information, etc. (or these data items may be included in user token 108).

At label 164, application 102 may transmit (via client device 101) a verification request to server 110, requesting verification of the short-range transceiver 105 associated with the user. This may occur after entry of short-range transceiver 105 into a short-range communication field of client device 101 such as, e.g., in response to a tap action between short-range transceiver 105 and client device 101 (e.g., the tap action at label 152). The tap action can comprise a tap, a swipe, a wave, another gesture in which the short-range transceiver 105 enters a short-range communication field of the client device 101, or any combination thereof. In some embodiments, the verification request from application 102 may be responsive to a verification request from processor 120 (as described above with reference to label 152). In some embodiments, the verification request can comprise NDEF and EMV data.

At label 166, application 102 may transmit (via client device 101) first type data to server 110, which may include some or all of the first type data received from short-range transceiver 105 (label 158). The first type data may include the first identifier, may include token 108, and may be NDEF data.

At label 168, application 102 may transmit (via client device 101) second type data to server 110, which may include some or all of the second type data received from short-range transceiver 105 (label 162). The second type data may include the second identifier, may include token 108, and may be EMV data.

At label 170, processor 120 may receive (e.g. via server 110) the first type data, which may be NDEF data. Processor 120 may obtain the first identifier from the first type data.

At label 172, processor 120 may receive (e.g. via server 110) the second type data, which may be EMV data. Processor 120 may obtain the second identifier from the second type data.

The order of read commands sent and type data transmitted/received is not critical. Thus, a command to read second type data may precede a command to read first type data, and the respective transmissions of second type data responsive to a command to read second type data may precede the respective transmissions of first type data responsive to a command to read first type data. For example, where the two data types are NDEF data and EMV data, respectively, an EMV read command may precede a NDEF read command, and the responsive transmission of EMV data may precede the responsive transmission of NDEF data.

At label 174, processor 120 may carry out a verification process based on the first identifier obtained from the first type data, and the second identifier obtained from the second type data. The verification process may include using the first identifier to look up user information in database 130 and using the second identifier to look up user information in database 130. The verification process may include comparing the user information obtained from the first identifier lookup to the user information obtained from the second identifier lookup to determine if the user information from each lookup corresponds to the same user and/or corresponds to the same short-range transceiver. In some embodiments, the verification process may include comparing the user information obtained from the first identifier lookup to the user information obtained from the second identifier lookup to determine if the user information from each lookup corresponds to the same short-range transceiver associated with the user. In some embodiments, if the second type data is EMV data, the verification process may include identifying a counter value used in generating a cryptogram in the EMV data and determining whether the counter value is within an acceptable range.

In some embodiments, at label 176, if token 108 includes a user key associated with the user, processor 120 may use the user key to authenticate the user as the user associated with short-range transceiver 105. Database 130 may store a copy of the user key, or a key associated with the user that may be used to generate a copy of the user key. Generating a copy of the user key based on the key associated with the user may include using a counter or other data derived or otherwise maintained in synchronization between processor 120, client device 101 and/or short-range transceiver 105.

At label 178, based on the results of the verification process (label 174) and any authentication process (label 176), processor 120 may send a verification message to application 102 (via client device 101) confirming that the user and/or short-range transceiver 105 are verified. Based on the verification, the user may proceed to carry out further actions, such as, for example, a purchase, deposit or withdrawal transaction. The verification message may include, or be accompanied by, additional data that may be used by the user or client device in carrying out any such further actions. Such additional data may include a token or key.

In an embodiment, processor 120 may instead send a denial notification (not shown) to application 102 (via client device 101), indicating that the user or the short-range transceiver has not been verified. A denial notification may include, or be accompanied by, additional data that may indicate a reason for the failure.

In some embodiments, application 102 may only send data of one type (such as, for example, first type data but not second type data, or vice-versa) or data of an unknown type. This may occur, for example, if short-range transceiver 105 moves out of range of the short-range communication field, or if short-range transceiver 105 is incapable of providing data of one or both types. In such cases, processor 120 may send a message (not shown) to application 102 requesting that the user try again and/or try again with a different short-range transceiver (e.g., a different contactless card). In some embodiments, application 102 may detect and alert the user to a potential problem (such as, e.g., receiving only first type data but not second type data, or vice-versa) without sending data to server 110 or receiving a message from processor 120.

FIG. 2 illustrates components of a client device 200 used in a user verification system according to one or more example embodiments. Client device 200 may be one or more of client devices 101, described above with reference to FIGS. 1A-1B. Client device 200 may include one or more applications 201, one or more processors 202, a short-range communications interface 203, a network interface 204, and memory (not shown). Application 201 may include a software application or executable program code to be executed on processor 202 and configured to carry out features described herein for any client devices, such as client device 101, and/or any of the features described herein with reference to application 102. Application 201 may be configured, for example, to transmit and/or receive data with other devices via client device 101, such as, e.g., via short-range communications interface 203 and/or network interface 204. For example, application 201 may be configured to initiate one or more requests, such as near field data exchange requests to a short-range transceiver (such as a contactless card). Application 201 may also be configured to provide a user interface via a display (not shown) for a user of the client device. Application 201 may be stored in memory in client device 200; the memory may include a read-only memory, write-once read-multiple memory and/or read/write memory, e.g., RAM, ROM, and/or EEPROM.

Processor 202 may include one or more processing devices such as a microprocessor, RISC processor, ASIC, etc., and may include associated processing circuitry. Processor 202 may include, or be connected to, memory storing executable instructions and/or data, as may be necessary or appropriate to control, operate or interface with the other features of client device 200, including application 201. Processor 202 (including any associated processing circuitry) may contain additional components including processors, memories, error and parity/CRC checkers, data encoders, anticollision algorithms, controllers, command decoders, security primitives and tamperproofing hardware, as necessary to perform the functions described herein.

Short-range communications interface 203 may support communication via a short-range wireless communication field, such as NFC, RFID, or Bluetooth. Short-range communications interface 203 may include a reader, such as a mobile device NFC reader. Short-range communications interface 203 may be incorporated into network interface 204, or may be provided as a separate interface.

Network interface 204 may include wired or wireless data communication capability. These capabilities may support data communication with a wired or wireless communication network, including the Internet, a cellular network, a wide area network, a local area network, a wireless personal area network, a wide body area network, a WiFi network, any other wired or wireless network for transmitting and receiving a data signal, or any combination thereof. Such network may include, without limitation, telephone lines, fiber optics, IEEE Ethernet 902.3, a wide area network, a local area network, a wireless personal area network, a wide body area network or a global network such as the Internet.

Client device 200 may also include a display (not shown). Such display may be any type of device for presenting visual information such as a computer monitor, a flat panel display, or a mobile device screen, including liquid crystal displays, light-emitting diode displays, plasma panels, and cathode ray tube displays.

Client device 200 may also include one or more device inputs (not shown). Such inputs may include any device for entering information into the client device that is available and supported by the client device 200, such as a touch-screen, keyboard, mouse, cursor-control device, touch-screen, microphone, digital camera, video recorder, or camcorder. The device inputs may be used to enter information and interact with the client device 200 and, by extension, with the systems described herein.

Client device 101 and/or application 102 require the capability of issuing data read commands for, and receiving, first type data and second type data. With respect to NDEF data (as the first type data) and EMV data (as the second type data), it should be noted that, presently, mobile devices (such as smartphones) running Google's Android® operating system are capable of handling both NDEF and EMV data (including issuing respective data read commands). While mobile devices (such as iPhones) running Apple's iOS® operating system are capable of handling NDEF data (including issuing NDEF data read commands), but not EMV data.

FIG. 3 illustrates components of a short-range transceiver 300 used in a user verification system according to one or more example embodiments. In one or more example embodiments, short-range transceiver 300 may be one or more of short-range transceiver 105, described above with reference to FIGS. 1A-1B. Short-range transceiver 300 may include, for example, a contactless card, a smart card, or may include a device with a varying form factor such as a fob, pendant or other device configured to communicate within a short-range communications field. Short-range transceiver 300 may include a processor 301, memory 302, applets 303-304, token 305 and short-range communications interface 306.

Processor 301 may include one or more processing devices such as a microprocessor, RISC processor, ASIC, etc., and may include associated processing circuitry. Processor 301 may include, or be connected to, memory storing executable instructions (such as, e.g., applet 303 and/or applet 304) and/or data, as may be necessary or appropriate to control, operate or interface with the other features of short-range transceiver 300. Processor 301 (including any associated processing circuitry) may contain additional components including processors, memories, error and parity/CRC checkers, data encoders, anticollision algorithms, controllers, command decoders, security primitives and tamperproofing hardware, as necessary to perform the functions described herein.

Memory 302 may be a read-only memory, write-once read-multiple memory and/or read/write memory, e.g., RAM, ROM, and EEPROM.

Memory 302 may be configured to store applets 303-304 and one or more tokens 305. Applets 303-304 may comprise one or more software applications configured to execute on processor 301, such as a Java Card applet that may be executable on a contactless card. However, it is understood that applets 303-304 are not limited to Java Card applets, and instead may be any software application operable on contactless cards or other devices having limited memory. Applets 303 and/or 304 may be configured to respond to one or more requests (such as near field data exchange requests) from a client device, including requests from a device having a reader such as a mobile device NFC reader. Applets 303 and 304 may be configured to read (or write) data, including token 305, from (or to) memory 302 and provide such data in response to a request. Applet 303 may be configured to respond to NDEF read commands and provide data according to the NDEF format. Applet 304 may be configured to respond to EMV read commands and provide data according to the EMV format. In some embodiments, the functionality of applets 303 and 304 may be combined in a single applet.

Token 305 may include a unique alphanumeric identifier assigned to a user of the short-range transceiver 300, and the identifier may distinguish the user of the short-range transceiver 300 from other users of other short-range transceivers (such as other contactless card users). In some example embodiments, token 305 may identify both a user and an account assigned to that user and may further identify the short-range transceiver (such as a contactless card) associated with the user's account. In some example embodiments, token 305 may include a key unique to the user with which the short-range transceiver is associated.

Short-range communications interface 306 may support communication via a short-range wireless communication field, such as NFC, RFID, or Bluetooth. Short-range transceiver 300 may also include one or more antennas (not shown) connected to short-range communications interface 306 to provide connectivity with a short-range wireless communications field.

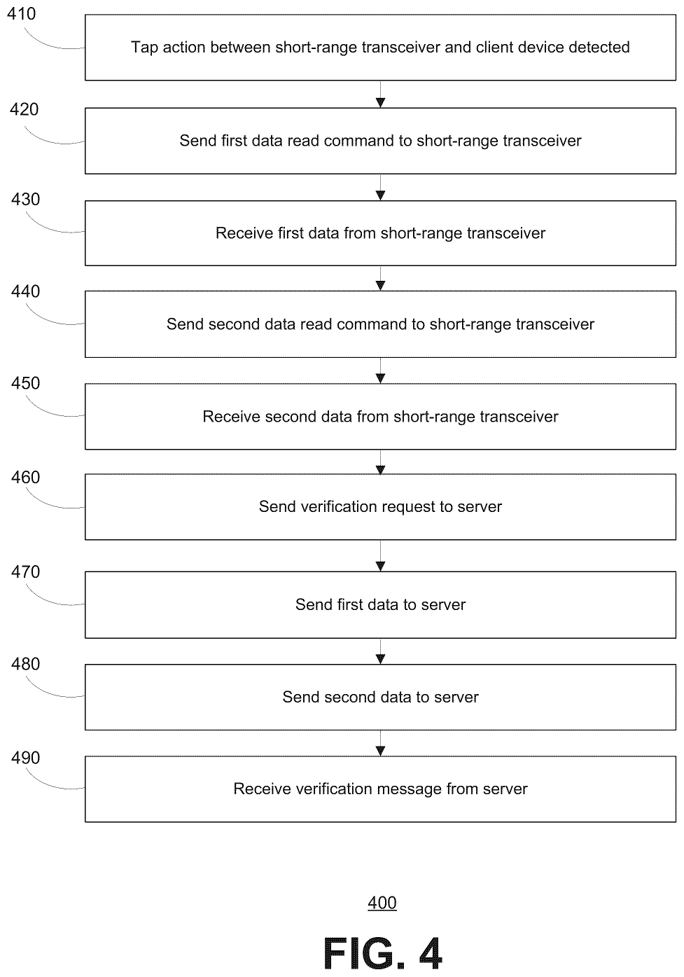

FIG. 4 is a flowchart illustrating a method of user verification 400 according to one or more example embodiments, with reference to components and features described above, including but not limited to the figures and associated description. User verification method 400 may be carried out by application 102 executing on client device 101 associated with the user. Short-range transceiver 105 is associated with the user.

At block 410, a tap action may be detected between short-range transceiver 105 and client device 101. The tap action may be in response to a prompt displayed on client device 101. As described above, short-range transceiver 105 may be a contactless card.

At block 420, application 102 may send to short-range transceiver 105 a first data read command to read data of a first type. Sending the first data read command may occur after entry of short-range transceiver 105 into a short-range communication field of client device 101 such as, e.g., in response to the tap action of block 410. As described above, the first data read command may be a NDEF read command and the first type data may be NDEF data.

At block 430, first type data may be received from short-range transceiver 105. Receiving first type data may occur in response to sending the first data read command (block 420). The received first type data may include a first identifier. The first identifier may be associated with the user and/or with short-range transceiver 105. In some embodiments, the received first type data may include token 108. In some embodiments, token 108 may include a user key associated with the user. As described above, the first data read command may be a NDEF read command and the first type data may be NDEF data.

At block 440, application 102 may send to short-range transceiver 105 a second data read command to read data of a second type. Sending the second data read command may occur after entry of short-range transceiver 105 into a short-range communication field of client device 101 such as, e.g., in response to tap action of block 410. In some embodiments, sending the second data read command may occur in response to a second tap action (not shown) between short-range transceiver 105 and client device 101. The second tap action may be in response to a prompt displayed on client device 101. As described above, the second data read command may be an EMV read command and the second type data may be EMV data.

At block 450, second type data may be received from short-range transceiver 105. Receiving second type data may occur in response to sending the second data read command (block 440). The received second type data may include a second identifier. The second identifier may be associated with the user and/or with short-range transceiver 105. In some embodiments, the received second type data may include token 108. In some embodiments, token 108 may include a user key associated with the user. As described above, the second data read command may be an EMV read command and the second type data may be EMV data.

As described above, the order of read commands sent and type data transmitted/received is not critical. Thus, a command to read second type data (block 440) may precede a command to read first type data (block 420), and the receipt of second type data responsive to a command to read second type data (block 450) may precede the receipt of first type data responsive to a command to read first type data (block 430).

At block 460, a verification request may be transmitted to server 110, requesting verification of the user and/or the short-range transceiver associated with the user based on the first identifier and the second identifier. The verification request may be accompanied by, or precede or trail, transmission of the first type data (including the first identifier) and/or the second type data (including the second identifier).

At block 470, the first type data (including the first identifier) may be sent to server 110. As described above, the first type data may be NDEF data.

At block 480, the second type data (including the second identifier) may be sent to server 110. As described above, the second type data may be EMV data.

At block 490, a verification message may be received from server 110. The verification message may be based on the results of a verification process (such as the verification process described above with reference to label 174 of FIG. 1B). The verification message may confirm that the user and/or short-range transceiver 105 are verified. Based on the verification, the user may proceed to carry out further actions, such as, for example, a purchase, deposit or withdrawal transaction.

In some embodiments, a message (not shown) may be received from server 110 requesting that the user try again and/or try again with a different short-range transceiver (e.g., a different contactless card).

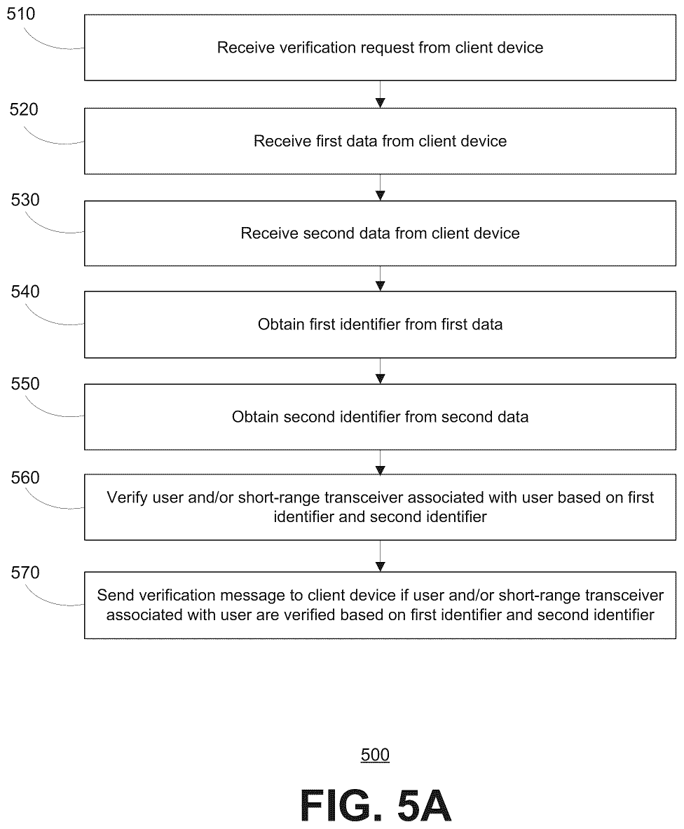

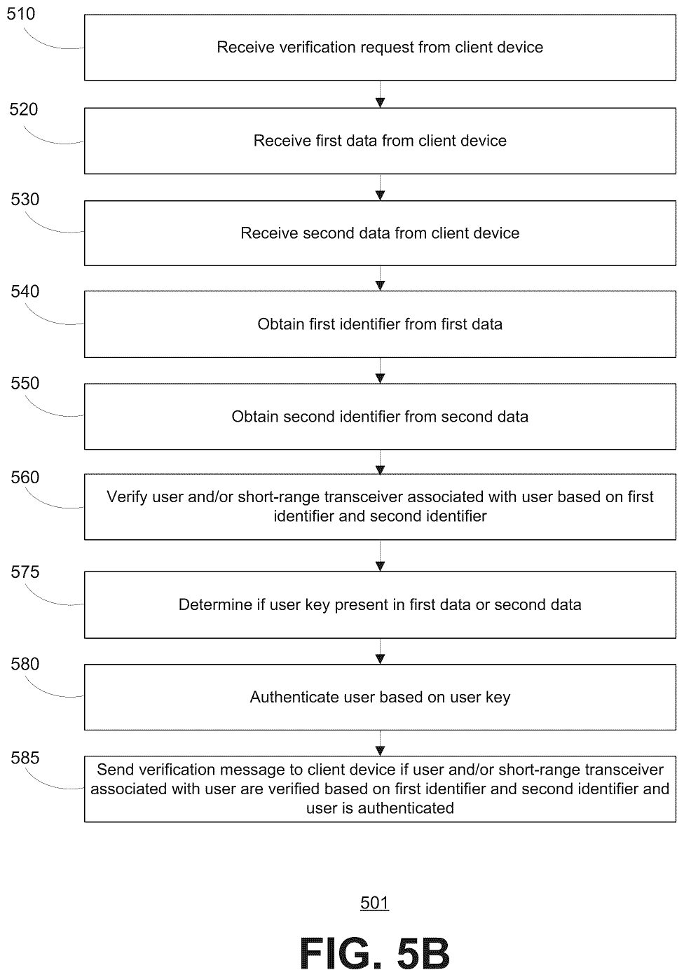

FIG. 5A is a flowchart illustrating a method of user verification 500 according to one or more example embodiments, with reference to components and features described above, including but not limited to the figures and associated description. User verification method 500 may be carried out by processor 120 in communication with, via server 110, client device 101.

At block 510, a verification request may be received from client device 101, requesting verification of the user and/or the short-range transceiver associated with the user based on a first identifier and a second identifier. The verification request may be accompanied by, or precede or trail, receipt of first type data (including the first identifier) and/or second type data (including the second identifier). In some embodiments, the verification request received from client device 101 may be responsive to a verification request previously sent to client device 101 (as described above with reference to label 152 of FIG. 1B).

At block 520, first type data (including a first identifier) may be received from client device 101. As described above, the first type data may be NDEF data.

At block 530, second type data (including a second identifier) may be received from client device 101. As described above, the second type data may be EMV data.

At block 540, the first identifier may be obtained from the received first type data. As described above, if the first type data is NDEF data, the first identifier may be obtained by extracting the first identifier from the NDEF data.

At block 550, the second identifier may be obtained from the received second type data.

As described above, if the second type data is EMV data, the second identifier may be obtained by extracting the second identifier from the EMV data.

At block 560, a verification process may be carried out. As described above with reference to label 174 of FIG. 1B, the verification process may include using the first identifier to look up user information in database 130 and using the second identifier to look up user information in database 130. The verification process may include comparing the user information obtained from the first identifier lookup to the user information obtained from the second identifier lookup to determine if the user information from each lookup corresponds to the same user. In some embodiments, the verification process may include comparing the user information obtained from the first identifier lookup to the user information obtained from the second identifier lookup to determine if the user information from each lookup corresponds to the same short-range transceiver associated with the user. In some embodiments, the verification process may include comparing the user information obtained from the first identifier lookup to the user information obtained from the second identifier lookup to determine if the user information from each lookup corresponds to the same user and the same short-range transceiver associated with the user.

At block 570, a verification message may be sent to client device 101. The verification message may be based on the results of a verification process (such as the verification process described above with reference to block 560). The verification message may confirm that the user and/or short-range transceiver 105 are verified.

In some embodiments, a message (not shown) may be sent to client device 101 requesting that the user try again and/or try again with a different short-range transceiver (e.g., a different contactless card).

FIG. 5B is a flowchart illustrating a method of user verification 501 according to one or more example embodiments, with reference to components and features described above, including but not limited to the figures and associated description. User verification method 501 may be carried out by processor 120 in communication with, via server 110, client device 101 associated with a user. Blocks 510 through 560 of method 501 include the same activity described above with reference to method 500 of FIG. 5A; method 501 then proceeds to block 575.

At block 575, it may be determined that a user key is present in the first type data or the second type data received from client device 101.

At block 580, the user may be authenticated based on the user key. As described above with reference to label 176 (FIG. 1B), database 130 may store a copy of the user key, or a key associated with the user that may be used to generate a copy of the user key. Generating a copy of the user key based on the key associated with the user may include using a counter or other data derived or otherwise maintained in synchronization between processor 120, client device 101 and/or short-range transceiver 105. The user may be authenticated, for example, if the user key received from client device 101 is matched to the user key obtained from, or generated from the key associated with the user and stored in, database 130. In some embodiments, the user may be authenticated, based on the user key received from client device 101, via other techniques.

At block 585, a verification message may be sent to client device 101. The verification message may be based on the results of the verification process described above with reference to block 560 and the user authentication process described above with reference to blocks 575-580. The verification message may confirm that the user and/or short-range transceiver 105 are verified. The verification may also confirm that the user has been authenticated.

In some embodiments, server 110 or client device 101 may send all or portions of the first type data, and/or all or portions of the second type data, to authorization network 140 as part of a transaction authorization process. For example, if the second type data is EMV data, server 110 or client device 101 may send all or portions of the EMV data, along with other data pertinent to a transaction, to authorization network 140. Authorization network 140 may process the data and reply with a transaction authorization message. If authorization network 140 authorizes the transaction, server 110 may use such authorization as a further indicia for verifying the user and/or short-range transceiver 105. In other embodiments, the authorization network 140 can be omitted from the transaction authorization process and the server 110 and/or client device 101 can perform this processing of the EMV data.

The description of embodiments in this disclosure provides non-limiting representative examples referencing figures and numerals to particularly describe features and teachings of different aspects of the disclosure. The embodiments described should be recognized as capable of implementation separately, or in combination, with other embodiments from the description of the embodiments. A person of ordinary skill in the art reviewing the description of embodiments should be able to learn and understand the different described aspects of the disclosure. The description of embodiments should facilitate understanding of the disclosure to such an extent that other implementations, not specifically covered but within the knowledge of a person of skill in the art having read the description of embodiments, would be understood to be consistent with an application of the disclosure

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A card verification system, comprising:
a database storing user identifier information for a plurality of contactless cards;
a contactless card comprising a processor and a memory, the memory storing first data of a first type, second data of a second type, a first applet configured to provide the first type data, and a second applet configured to provide the second type data, wherein the contactless card is associated with a user; and
a server configured to communicate over a network with the contactless card and the database;
wherein, after entry into a short-range communication field, the contactless card is configured to transmit the first type data and the second type data to the server, and
wherein, after receipt of the first type data and the second type data, the server is configured to:
determine a first user identifier based on the first type data,
determine a second user identifier based on the second type data,
determine whether the first user identifier and the second user identifier both correspond to the contactless card associated with the user, and
transmit a card verification message.

2. The card verification system of claim 1, wherein the short-range communication field comprises near field communication (NFC).

3. The card verification system of claim 2, wherein the first type data comprises NFC data exchange format data.

4. The card verification system of claim 3, wherein the second type data comprises Europay Mastercard Visa (EMV) data.

5. The card verification system of claim 4, further comprising a client device is associated with a point of sale (POS) system, wherein the client device is configured to generate the short-range communication field.

6. The card verification system of claim 5, wherein the client device stores a client application comprising instructions for execution by the client device, and wherein the client application is further configured to transmit the second type data to a card authorization network.

7. The card verification system of claim 1, wherein the card verification message indicates that the contactless card has been successfully verified.

8. The card verification system of claim 7, wherein the client device stores a client application comprising instructions for execution by the client device, and wherein the client application is further configured to proceed with a transaction using the contactless card.

9. The card verification system of claim 1, wherein the card verification message indicates that the contactless card has not been successfully verified.

10. The card verification system of claim 9, wherein the client device stores a client application comprising instructions for execution by the client device, and wherein the client application is further configured to display an instruction to attempt verification using a different contactless card.

11. A method for card verification, comprising:
establishing a database storing user identifier information for a plurality of contactless cards;
receiving, via a network, a card verification request to verify a contactless card, the card verification request generated in response to entry by the contactless card into a short-range communication field, the card verification request accompanied by first type data read from the contactless card and by second type data read from the contactless card, wherein the contactless card is associated with a user;
determining a first user identifier based on the first type data;
determining a second user identifier based on the second type data;
determining whether the first user identifier and the second user identifier both correspond to the contactless card associated with the user; and
transmitting, via the network, a card verification message.

12. The method of claim 11, wherein determining the first user identifier based on the first type data comprises searching the database using at least a portion of the first type data.

13. The method of claim 12, wherein determining the second user identifier based on the second type data comprises searching the database using at least a portion of the second type data.

14. The method of claim 13, wherein at least one of the first type data or the second type data comprises a key associated with the user.

15. The method of claim 14, further comprising using the key to authenticate the user.

16. The method of claim 11, wherein the short-range communication field comprises near field communication (NFC).

17. The method of claim 16, wherein the first type data comprises NFC data exchange format data and wherein the second type data comprises Europay Mastercard Visa (EMV) data.

18. The method of claim 17, further comprising transmitting the second type data to a card authorization network.

19. The method of claim 18, further comprising receiving a transaction authorization response from the card authorization network.

20. A method for card verification, comprising:
establishing a database storing user identifier information for a plurality of contactless cards;
providing a contactless card configured for data communication via near field communication (NFC), the contactless card comprising a processor and a memory, the memory storing NFC data exchange format (NDEF) data, Europay Mastercard Visa (EMV) data, a first applet configured to provide the NDEF data responsive to an NDEF read request, and a second applet configured to provide the EMV data responsive to an EMV read request, wherein the contactless card is associated with a user; and
providing a server in communication with the contactless card via a network, the server configured to receive the NDEF data and the EMV data and transmit a card verification message, the card verification message based on determining whether a first user identifier associated with the NDEF data and a second user identifier associated with the EMV data both correspond to the contactless card associated with the user.
